(19) United States
(12) Patent Application Publication
(10) Pub. No.: US 2016/0321194 A1
(43) Pub. Date: Nov. 3, 2016

(54) STORAGE DEVICE, CONTROLLER, AND CONTROL METHOD

(71) Applicant: KABUSHIKI KAISHA TOSHIBA, Tokyo (JP)

(72) Inventors: Kazuya Takada, Kamakura Kanagawa (JP); Kenji Yoshida, Kamakura Kanagawa (JP)

(21) Appl. No.: 14/835,410

(22) Filed: Aug. 25, 2015

Related U.S. Application Data
(60) Provisional application No. 62/153,712, filed on Apr. 28, 2015.

(51) Int. Cl. G06F 12/14; H04L 9/08

(52) U.S. Cl. CPC G06F 12/1408; H04L 9/0825; G06F 2212/1052

(57) ABSTRACT

According to one embodiment, a storage device includes a storage medium configured to store second data groups including first data groups, each of the first data groups including user data encrypted with a common encryption key and first information concerned with the encryption key, and a controller configured to hold second information regarding a latest encryption key, read one of the first data groups included in one of the second data groups, compare the second information and the first information acquired from the one of the first data groups, and stop a read operation of reading the first data groups included in the second data groups upon the first information being different from the second information.

### CROSS-REFERENCE TO RELATED APPLICATIONS

This application claims the benefit of U.S. Provisional Application No. 62/153,712, filed Apr. 28, 2015, the entire contents of which are incorporated herein by reference.

### FIELD

Embodiments described herein relate generally to a storage device, a controller, and a control method.

### BACKGROUND

In recent years, a storage device to which a host can directly accesses through an Application Programming Interface (API) has been developed. The storage device manages data on a disk in the unit of a data group which includes two or more sectors. To the storage device, a sector is equivalent to a unit of reading or writing data from or into a disk. The storage device therefore receives a read request from a host in the unit of the data group. In such a storage device, when data is encrypted and written on a storage medium in order to ensure data security, two or more sectors in the data group may be encrypted with an encryption key in the common generation. It should be noted that the conventional storage device generally does not have a means to allow a host to notify the conventional storage device that the host attempts to collectively access a data group and thus keeps managing the generation information items of encryption keys by each the sector. The conventional storage device therefore needs to determine each and every sector for the generation information items of encryption keys are same. Namely, the storage device to which the host can directly accesses needs to access upon receipt of a read request from the host every sector included in a data group and inspect for the generation information items of encryption keys.

### BRIEF DESCRIPTION OF THE DRAWINGS

FIG. 1 is a block diagram illustrating a structure of a storage device in an embodiment;

FIG. 2A is a view illustrating an exemplary data unit managed by the storage device;

FIG. 2B is a view illustrating another exemplary data unit managed by the storage device; and

FIG. 3 is a flow chart illustrating an exemplary operation of the storage device in the embodiment.

### DETAILED DESCRIPTION

In general, according to one embodiment, a storage device comprises: a storage medium configured to store second data groups, each of the second data groups including first data groups, each of the first data groups including user data encrypted with a common encryption key and first information concerned with the encryption key; and a controller configured to hold second information regarding a latest encryption key used at present to encrypt externally received data and to decrypt data, read one of the first data groups included in one of the second data groups according to an externally supplied read request, compare the second information and the first information acquired from the read one of the first data groups, and stop a read operation of reading the first data groups included in the one of the second data groups upon the first information and the second information being different from each other.

Embodiments will be described hereinafter with reference to the accompanying drawings.

### First Embodiment

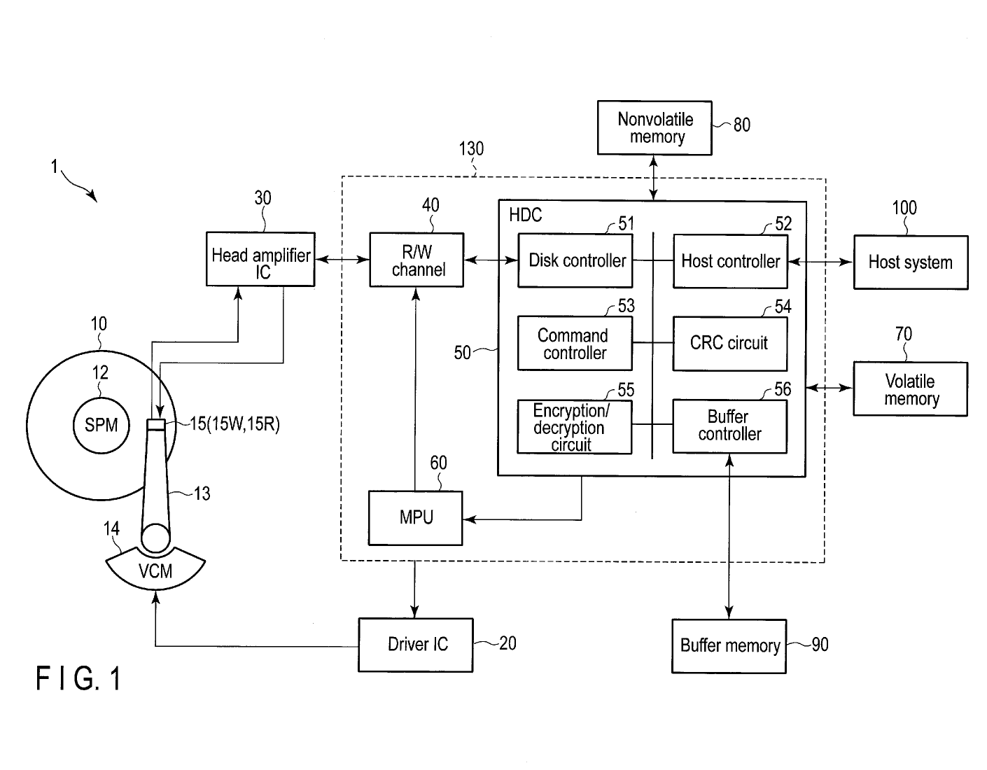

FIG. 1 is a block diagram illustrating a structure of a storage device 1 in the first embodiment. The storage device 1 is constructed as such a storage device to which external devices can directly accesses through an Application Programming Interface (API). The storage device 1 manages data (data item) transmitted from the external devices in a unit of a data group including data, an identifier for identifying the data, and meta data of the data. It should be noted that a data group may be called an object, and that an identifier may be called an object ID or a key value.

The storage device 1 has a function of encrypting or decrypting data. A storage device which has a function of encrypting or decrypting data may be called a self-encrypting device. At the time of read operation, a self-encrypting drive examines generation information (KeyGen) of the encryption key for decrypting data to read (hereafter also referred to as “encryption key generation information” or “key generation information”), and determines whether the encryption key generation information is new or old. If the determined key generation information indicates that of a latest generation of an encryption key that is presently used (hereinafter sometimes referred to as a “new encryption key”), a self-encrypting drive will decode data with a new encryption key. Moreover, if the key generation information indicates that of an old generation of an encryption key (hereinafter sometimes referred to as an “old encryption key”), the self-encrypting drive cannot decrypt data with a new encryption key so that it outputs to a host another data having a particular pattern.

The storage device 1 in the present embodiment will be explained as a disk drive having a disk 10 as a storage medium.

As illustrated in FIG. 1, the storage device 1 includes a head disk assembly (HDA), a driver IC 20, a head amplifier integrated circuit (hereinafter referred to as a “head amplifier IC”) 30, a volatile memory 70, a nonvolatile memory 80, a buffer memory (a memory) 90, and a system controller 130 of a single-chip integrated circuit. The storage device 1 is connected to a host system (hereinafter referred to as a “host”) 100. The storage device 1 writes into the disk 10 data transmitted from the host 100, and transmits to the host 100 data read from the disk 10.

The host 100 is a server, a personal computer, or an interface device. Any application or the like which the host 100 has can have a direct access to the storage device 1 through an Application Programming Interface (an API).

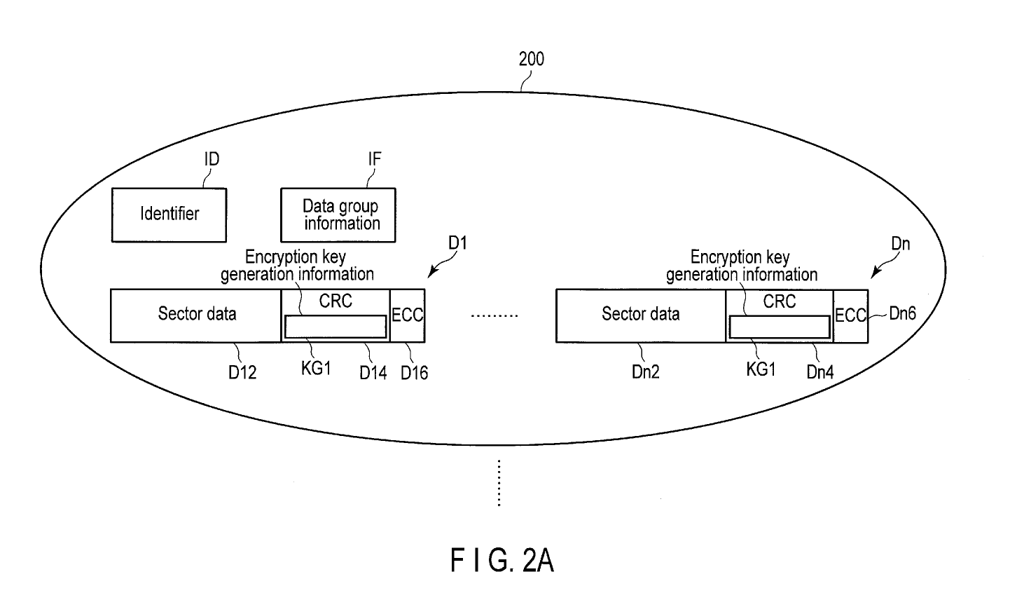

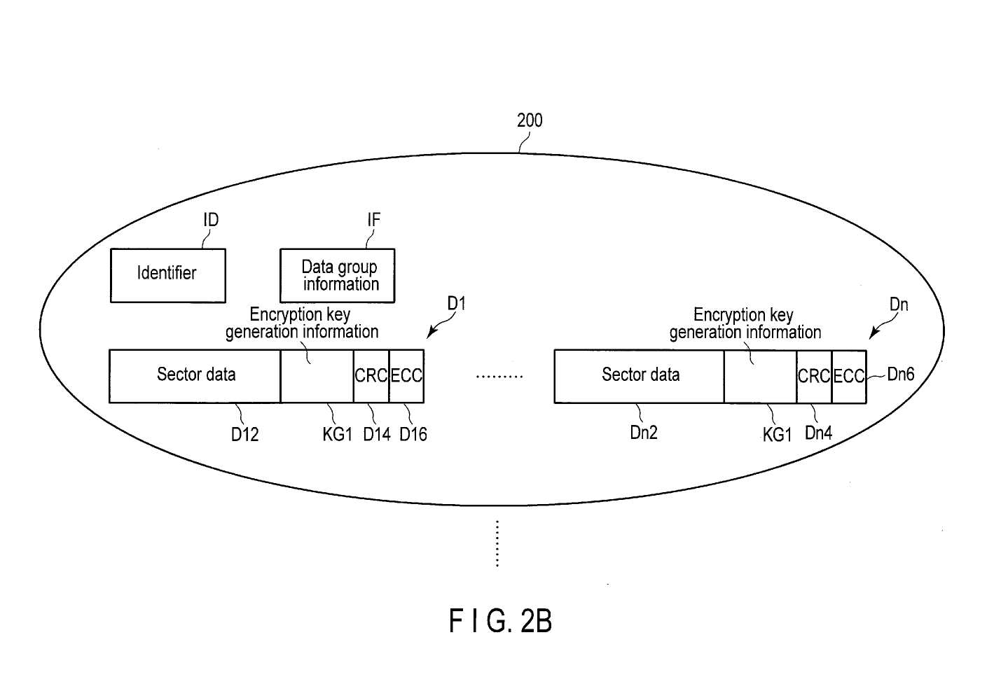

FIG. 2A and FIG. 2B are views illustrating the respective examples of a data unit which the storage device 1 manages. The storage device 1 manages data transmitted from the host 100 in the unit of a data group 200. As illustrated in FIG. 2A, the data group 200 includes one or more sectors (a first data group) D1-Dn, an identifier ID, and data group information IF. The data group (a second data group) 200 includes two or more data items continuously arranged from the sector D1 to the sector Dn. Here, the sector Dn holds an n-th data whose top data is held in the sector D1.

As illustrated in FIG. 2A, the sectors D1-Dn respectively include sector data items D12-Dn2, cyclic redundancy check (CRC) data items D14-Dn4, and the error correction code (ECC) data items D16-Dn6. The sectors D1-Dn may respectively include further data items in addition to these data items that have just mentioned. Furthermore, there is nothing wrong with the structure in which the sectors D1-Dn respectively include the common encryption key generation information KG1, as illustrated in FIG. 2A. In the following, data will be explained as having such a data structure as illustrated in FIG. 2A.

The sector data items D12-Dn2 are user data items transmitted from the host 100, for example.

The CRC data items D14-Dn4 are individually used for error detection. The CRC data items D14-Dn4 are provided in order to prevent any erroneous detection which may occur in a rare probability in an ECC data items D16-Dn6 described later. The CRC data items D14-Dn4 individually include the common encryption key generation information KG1.

The common encryption key generation information KG1 is indicative of the generation of encryption keys. The common encryption key generation information KG1 will be incremented whenever encryption key are updated. It should be noted that a new encryption key is the latest encryption key now in use, and that the old encryption key is an encryption key which belongs to the old generation and was used before the new encryption key. Any formerly used encryption key may be called as an old encryption key.

The ECC data items D16-Dn6 are used to correct the respective sector data items D12-Dn2 for any error. Moreover, when the number of bytes of an ECC data is made to increase, the probability of the erroneous detection of an error correction will be reduced.

The identifier ID is the information for identifying the data group 200. The data group information IF is the metadata of the data group 200. Furthermore, the data group information IF does not need to be included in the data group 200.

As illustrated in FIG. 1, the HDA includes the disk 10, a spindle motor (SPM) 12, an arm 13 having a head 15, and a voice coil motor (VCM) 14. The disk 10 is rotated by the SPM 12. The arm 13 and the VCM 14 are structured an actuator. The actuator moves the head 15 carried in the arm 13 to a particular position on the disk 10 by the drive of the VON 14. It should be noted that the HDA may include at least one disk 10 and at least one head 15.

The head 15 includes a slider as its main part, and has a write head 15W and a read head 15R, each mounted on the slider. The read head 15R reads data (data item) on the disk 10. The write head 15W writes data on the disk 10.

The driver IC 20 controls the drive of the SPM 12 and that of the VCM 14.

The head amplifier IC 30 includes a read amplifier and a write driver. The read amplifier amplifies a read signal read by the read head 15R, and transmits it to a read/write (R/W) channel 40 in the system controller 130. On the other hand, a write driver transmits to the write head 15W a write current according to the write data output from the R/W channel 40.

The volatile memory 70 is a semiconductor memory which loses preserved data when power supply is cut off. The volatile memory 70 stores data, etc., which each part of the storage device 1 uses upon execution of processing. The volatile memory 70 is a synchronous dynamic random access memory (SDRAM), for example.

The nonvolatile memory 80 is a semiconductor memory which keeps holding preserved data even if power supply is cut off. The nonvolatile memory 80 is a NOR or NAND flash read-only memory (ROM), for example.

The buffer memory 90 is a semiconductor memory which temporarily holds data, etc., which are transmitted and received between the disk 10 and the host 100. The buffer memory 90 may be constituted as a single unit with the volatile memory 70. The buffer memory 90 may be a dynamic random access memory (DRAM), a SDRAM, a ferroelectric random access memory (FeRAM), a magnetoresistive random access memory (MRAM), or the like, for example.

The system controller 130 includes the R/W channel 40, the hard disk controller (HDC) (controller) 50, and the microprocessor (MPU) 60. Each part of the storage device 1 other than the system controller 130 may be called external device.

The R/W channel 40 performs signal conditioning of both read data and write data. Moreover, the R/W channel 40 subjects read data to an error correction process, and write data to a process in which error correction codes are generated and added. Both of these processes belong to an ECC process. Furthermore, the HDC 50 described later may perform an ECC process.

The HDC 50 controls the data transfer between the host 100 and the R/W channel 40.

The HDC 50 includes a disk controller 51, a host controller 52, a command controller 53, a CRC circuit 54, an encryption/decryption circuit 55, and a buffer controller 56. In this embodiment, these parts are connected to a bus, etc. These parts of the HDC 50 constitute an acquisition section which acquires a read data, a write data, and information relevant to both data items, and a control section which controls the process of transmitting, encrypting and decrypting read data and write data.

The disk controller 51 is connected with the R/W channel 40, and performs control relevant to the disk 10 through the R/W channel 40.

The host controller 52 controls data transfer with respect to the host 100.

The command controller 53 performs control concerning the write command or read command received from the host 100.

The CRC circuit 54 generates CRC data D14-Dn4 based on the data (write data) transmitted from the host 100 through the host controller 52, and transmits to the R/W channel 40 the data having been obtained by adding the CRC data D14-Dn4 to write data. Moreover, the CRC circuit 54 performs error detection (CRC process) using the CRC data D14-Dn4 added to the data (read data) read from the disk 10. Moreover, the CRC circuit 54 performs the process of encoding the common encryption key generation information KG1, which is used for making a distinction whether an encryption key is new or old (distinguishing between a new encryption key and an old encryption key), and including the coded encryption key generation information in the CRC data D14-Dn4, and the process of decoding the read data into encryption key generation information. It should be noted that encryption key generation information may be added to sector data D12-Dn2, as illustrated in FIG. 2B, instead of included in CRC data D14-Dn4, as illustrated in FIG. 2A.

The encryption/decryption circuit 55 subjects data (write data or read data) to encryption process or decryption process using a new encryption key held in an internal memory which is not illustrated. The encryption/decryption circuit 55 always holds only a new encryption key now in use in the internal memory as an encryption key for performing encryption/decryption process. Moreover, the encryption/decryption circuit 55 causes an internal memory (register) to keep the encryption key generation information having been decoded by the CRC circuit 54, and determines whether the encryption key generation information belongs to a new generation or an old generation. The encryption/decryption circuit 55 may summarize the results of distinction between the new and the old in a table for every data, and store them in a memory such as a buffer memory 90, for example.

For example, the encryption/decryption circuit 55 first acquires encryption key generation information on any one sector of the sectors D1-Dn included in the particular data group 200 (the first key generation information), in the event that a request to read from the disk 10 the particular data group 200 is received from the host 100. The encryption/decryption circuit 55 compares the encryption key generation information on the acquired sector D1 (the first key generation information [first information]) and the encryption key generation information on the managed new encryption key (the second key generation information [second information]). The encryption/decryption circuit 55 generates data having a particular pattern (particular data), in the event that the first key generation information and the second key generation information are not coincided. The encryption/decryption circuit 55 outputs as a response the data having the particular pattern through the host controller 52 to the host 100. Furthermore, it is also possible in the event that the first key generation information and the second key generation information are not in agreement with each other to cause the MPU 60, which will be described later, to generate data having a particular pattern and to output the data to the host 100 in response to the signal output from the encryption/decryption circuit 55. Here, data having a particular pattern is a particular eigenvalue. For example, data having a particular pattern is data having a pattern wholly made of 0's, or data having a pattern wholly made of 1's, or data with a pattern set up with firmware, or data with a random pattern. Furthermore, the encryption/decryption circuit 55 stops decoding sector data items D12-Dn2 held in those sectors that are other than the acquired sector D1, namely, the remaining sectors D2-Dn included in the data group 200, in the event that the first key generation information and the second key generation information are not in agreement with each other.

The buffer controller 56 is connected to the buffer memory 90, and controls data transmitted to or received from the buffer memory 90. The buffer controller 56 temporarily stores in the buffer memory 90 the data having been read from the disk 10 or the data to be written on the disk 10 based on the instructions from the MPU 60, for example.

The MPU 60 is a main controller which controls each part of the storage device 1. The MPU 60 controls the VCM 14 through the driver IC 20, and performs servo control to position the head 15. Furthermore, the MPU 60 has control over the operation of writing data on the disk 10, and performs control on determination of the storage destination for the write data transmitted from the host 100. Moreover, the MPU 60 controls each part according to the signal from the HDC 50. For example, the MPU 60 stops the read operation of the head 15 in response to the signal from the HDC 50, in the event that the first key generation information and the second key generation information are not in agreement with each other. Furthermore, the MPU 60 performs on firmware various processes which the various parts of the storage device 1 execute.

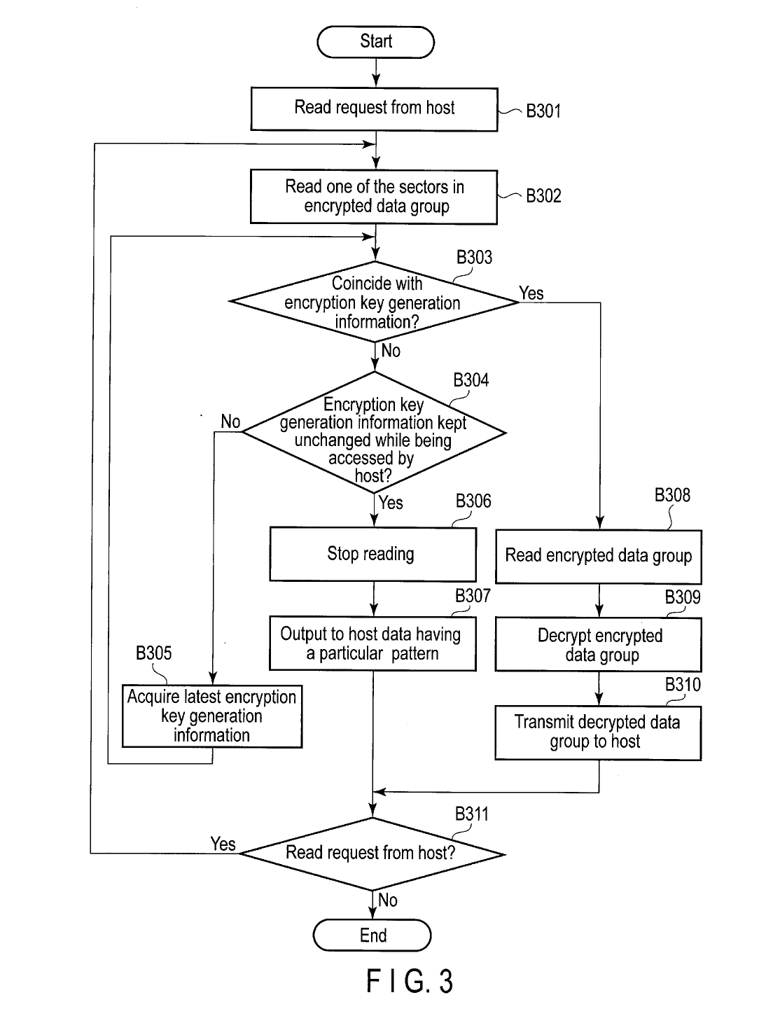

FIG. 3 is a flow chart illustrating an exemplary operation of the storage device in the embodiment. In FIG. 3, two or more encrypted data groups 200 (FIG. 2) are written on the disk 10 of the storage device 1. Hereinafter, the encrypted data group 200 may sometimes be referred to as the data group 200 for convenience of explanation. In the storage device 1, two or more sectors D1-Dn included in the data group 200 are encrypted with the respective encryption keys, all having relation to the common encryption key generation information KG1.

In B301, the HDC 50 receives a read request from the host 100.

In B302, the HDC 50 reads any one of the sectors that are on the disk 10 and hold a particular data group 200 which the host 100 requests the HDC 50 to read.

In B303, the HDC 50 compares the encryption key generation information on an encryption key of a sector which has been first read (first key generation information) and the encryption key generation information on a new encryption key (second key generation information), and determines whether the first key generation information and the second key generation information are coincided with each other.

When it is determined that the first key generation information and the second key generation information are not in agreement (NO in B303), the HDC 50 determines in B304 whether the encryption key generation information on an encryption key is updated while being accessed by the host 100.

When it is determined that encryption key generation information is not kept unchanged while being accessed by the host (NO in B304), the HDC 50 acquires in B305 the updated latest encryption key generation information, and returns to the process of B303.

When it is determined that encryption key generation information is kept unchanged while being accessed by the host (YES in B304), the HDC 50 stops the head 15 performing the read operation in B306. Here, the HDC 50 can also suspend the process of decoding sector data in the event that the sector data forming the data group 200 and included in sectors other than the sector having been read at the outset is already acquired.

In B307, the HDC 50 generates data having a particular pattern, outputs to the host 100 as a response the generated data having the particular pattern, and advances to the process of B311.

On the other hand, the HDC50 advances to the process of B308 when it is determined in B303 that the first key generation information and the second key generation information are in agreement (YES in B303).

In B308, the HDC 50 reads from the disk 10 the encrypted data group 200 which is requested by the host 100

In B309, the HDC 50 decrypts the read data group 200 using the new encryption key held in the internal memory.

In B310, the HDC 50 transmits the decrypted data group 200 to the host 100, and advances to the process of B311.

In B311, the HDC 50 determines whether there are other (or next) read requests from the host 100. When it is determined that there is a read request (YES in B311), the HDC 50 returns to the process of B302. When it is determined that there is no read request (NO in B311), the HDC 50 ends the process.

It should be noted that the above-mentioned operation illustrated in FIG. 3 may be performed by the MPU 60 on firmware.

The storage device 1 in the present embodiment first reads any one sector of two or more sectors, when a request to read the encrypted particular data group 200 is received from the host 100. The storage device 1 determines using the HDC 50 whether the encryption key generation information on a sector having been read at the outset from a particular data group is coincided with the latest encryption key generation information. It should be noted that all the sectors in the particular data group 200 ought to have the common encryption key generation information. Therefore, the encryption key generation information on a sector having been selected from the data group 200 and having been read at the outset makes it possible for the storage device 1 to determine whether the remaining sectors that have not yet been read should be read or not. Namely, when it is found that the encryption key generation information on a sector having been read at the outset from a particular data group is not coincided with the latest encryption key generation information, the remaining sectors need not be read.

Therefore, the storage device 1 in the present embodiment can avoid a retry operation in which all the remaining sectors are successively read after the selected one of the sectors of the data group 200 has been read at the outset. Moreover, the storage device 1 can eliminate a process of determining encryption key generation information on each and every sector included in the data group 200. As a result, the storage device 1 will be accelerated in respect of the response to the host 100.

Furthermore, the storage apparatus 1 in the above-mentioned embodiment can be also applied to a solid-state drive (SSD) which uses a NAND flash memory as a storage medium.

Moreover, the HDC 50 in the storage device 1 of the above-mentioned embodiment reads any one sector, which is on the disk 10 and is included in the particular data group 200, upon receipt of a read request from the host 100. However, it is also possible for the HDC 50 to first read a sector which is at the front of the data group 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage medium configured to store second data groups, each of the second data groups including first data groups, each of the first data groups including user data encrypted with a common encryption key and first information concerned with the encryption key; and
a controller configured to hold second information regarding a latest encryption key used at present to encrypt externally received data and to decrypt data, read one of the first data groups included in one of the second data groups according to an externally supplied read request, compare the second information and the first information acquired from the read one of the first data groups, and stop a read operation of reading the first data groups included in the one of the second data groups upon the first information and the second information being different from each other.

2. The storage device of claim 1, wherein the controller outputs particular data as a read result of the one of the first data groups upon the first information and the second information being different from each other.

3. The storage device of claim 1, wherein the controller outputs particular data as a read result of the first data groups after stopping the read operation.

4. The storage device of claim 3, wherein the particular data comprises data different from each of the first data groups.

5. The storage device of claim 3, wherein the particular data comprises data having any one of a pattern of all 0's, a pattern of all 1's, a newly set up pattern, and a random pattern.

6. The storage device of claim 1, wherein the one of the first data groups comprises a top first data group of the first data groups included in the one of the second data groups.

7. The storage device of claim 1, wherein the first information comprises information for identifying the encryption key used for encrypting the first user data included in the one of the first data groups, and the second information is information for identifying the latest encryption key.

8. A controller comprising:
an acquisition section configured to acquire from one of second data groups, each of the second data groups including first data groups, each of the first data groups including user data encrypted with a common encryption key and first information concerned with the encryption key, the first information about the encryption key of one of the first data groups; and
a control section configured to hold second information on a latest encryption key used at present to encrypt externally input data and to decrypt data, compare the first information and the second information, and stop subjecting the first data groups to decryption upon the first information and the second information being different from each other.

9. The controller of claim 8, wherein the control section outputs particular data upon the first information and the second information being different from each other.

10. The controller of claim 9, wherein the particular data comprises data different from each of the first data groups.

11. The controller of claim 9, wherein the particular data comprises data having any one of a pattern of all 0's, a pattern of all 1's, a newly set up pattern, and a random pattern.

12. The controller of claim 8, wherein the one of the first data groups comprises a top first data group of the first data groups.

13. The controller of claim 8, wherein the first information comprises information for identifying the encryption key used for encrypting the first user data included in the one of the first data groups, and the second information is information for identifying the latest encryption keys.

14. A method of controlling read operation applied to a storage device comprising a storage medium storing second data groups, each of the second data groups including first data groups, each of the first data groups including user data encrypted with a common encryption key and first information concerned with the encryption key, the method comprising:
reading one of the first data groups included in one of the second data groups according to an externally supplied read request;
comparing the first information acquired from the read one of the first data groups and second information regarding a latest encryption key used at present to encrypt externally received data and to decrypt data and
stopping a read operation of reading the first data groups included in the one of the second data groups upon the first information and the second information being different from each other.

15. The method of claim 14, further comprising outputting particular data as a read result of the one of the first data groups upon the first information and the second information being different from each other.

16. The method of claim 14, further comprising outputting particular data as a read result of the first data groups after having stopped the read operation.

17. The method of claim 16, wherein the particular data comprises data different from each of the first data groups.

18. The method of claim 16, wherein the particular data comprises data having any one of a pattern of all 0's, a pattern of all 1's, a newly set up pattern, and a random pattern.

19. The method of claim 14, wherein the one of the first data groups comprises a top first data group of the first data groups included in the one of the second data groups.

20. The method of claim 14, wherein the first information comprises information for identifying the encryption key used for encrypting the first user data included in the one of the first data groups, and the second information is information for identifying the latest encryption key.
